(19) United States
(12) Patent Application Publication
(10) Pub. No.: US 2010/0061563 A1
(43) Pub. Date: Mar. 11, 2010

(54) ENTERTAINMENT SYSTEM AND EARPHONE

(75) Inventors: Oliver Gelhard, Hannover (DE); Christian Grone, Neustadt (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser electronic GmbH & Co. KG, Wedemark (DE)

(21) Appl. No.: 12/554,461

(22) Filed: Sep. 4, 2009

(30) Foreign Application Priority Data
Sep. 8, 2008 (DE) 102008046048.6

(51) Int. Cl. G10K 11/16

(52) U.S. Cl. 381/71.4

(57) ABSTRACT

There is provided an entertainment system comprising at least one seat, an electronic unit (100) for active noise reduction in the seat and at least one headphone (300). The headphone has an electro-acoustic reproduction transducer (310), a microphone (330) for recording interference signals and an adjusting unit (320) having an active filter for correcting a frequency response characteristic of the output signal of the microphone, for performing pre-filtration for active noise reduction and for the output of a corrected and filtered signal. The electronic unit (100) performs active noise reduction based on the corrected and filtered signal of the adjusting unit (320).

The present invention concerns an entertainment system and an earphone.

Inflight entertainment systems are used for example in aircraft, wherein at least one headphone connection as well as operating elements for the selection of an audio channel are typically provided on a seat. In more recent inflight entertainment systems, typically an LCD screen is provided either in the backrest of a seat in front or such a screen is provided in the seat in such a way that it can be folded away. In addition thereto, the system includes operating elements to be able to suitably select the audio and video channels. To improve the quality of reproduction by headphones used, a noise-reducing headphone for example can be provided. In that case the electronic system required for noise reduction can be provided both in the headphone and also in the seat.

DE 10 2005 016204 discloses a headphone with a noise reduction unit arranged for example in a seat.

With inflight entertainment systems in which the noise reduction electronics are arranged in the seat, it can happen that the acoustics of the headphone used do not match the noise reduction electronic system employed.

Thus an object of the present invention is to provide an entertainment system in which any headphone, that is to say with any acoustics, can be used.

That object is attained by an entertainment system as set forth in claim 1, by an earphone as set forth in claim 3 and by a method as set forth in claim 4.

Thus there is provided an entertainment system with at least one seat, an electronic unit for active noise reduction in the seat and at least one phone, for example a headphone, an earphone or an in-ear phone. The headphone has an electro-acoustic reproduction transducer, a microphone for recording interference signals and an adjusting unit having an active filter for correcting a frequency response characteristic of the output signal of the microphone, for effecting pre-filtering for active noise reduction and for outputting a corrected and filtered signal. The electronic unit performs active noise reduction based on the corrected and filtered signal of the adjusting unit.

In accordance with an aspect of the present invention the electronic unit has a filter for active noise reduction and an amplifier for amplifying the actively noise-reduced signal. The filtered and corrected signal of the adjusting unit is fed to the filter in the electronic unit.

The invention also concerns an earphone having an electro-acoustic transducer, a microphone for recording interference signals and an adjusting unit having an active filter. The adjusting unit serves to receive the output signal of the microphone, to correct the frequency response characteristic of the output signal, to perform pre-filtering for active noise reduction and to output the filtered and compensated signal.

The invention also concerns a method of controlling an entertainment system having at least one seat, an electronic unit for active noise reduction in the seat and at least one headphone having an electro-acoustic reproduction transducer, a microphone for recording interference signals and an adjusting unit having an active filter. By means of the active filter, the frequency response characteristic of the output signal is corrected, pre-filtering for active noise reduction is effected and the corrected and filtered signal is outputted. Active noise reduction is effected based on the corrected and filtered signal.

The invention concerns the concept of providing an active filter in a headphone or earphone, which is fed by a microphone supply voltage which is fed for example by the noise reduction electronic system in a seat. The filter in the earphone serves in that case to adjust the noise reduction function of the earphone in the way as is present in the case of an earphone with standard noise reduction. Preferably the filter is adapted to save on current as the supply voltage is coupled to a 4.7 kOhms resistor.

Further configurations of the invention are subject-matter of the appendant claims.

Embodiments by way of example and advantages of the invention are described in greater detail hereinafter with reference to the drawing.

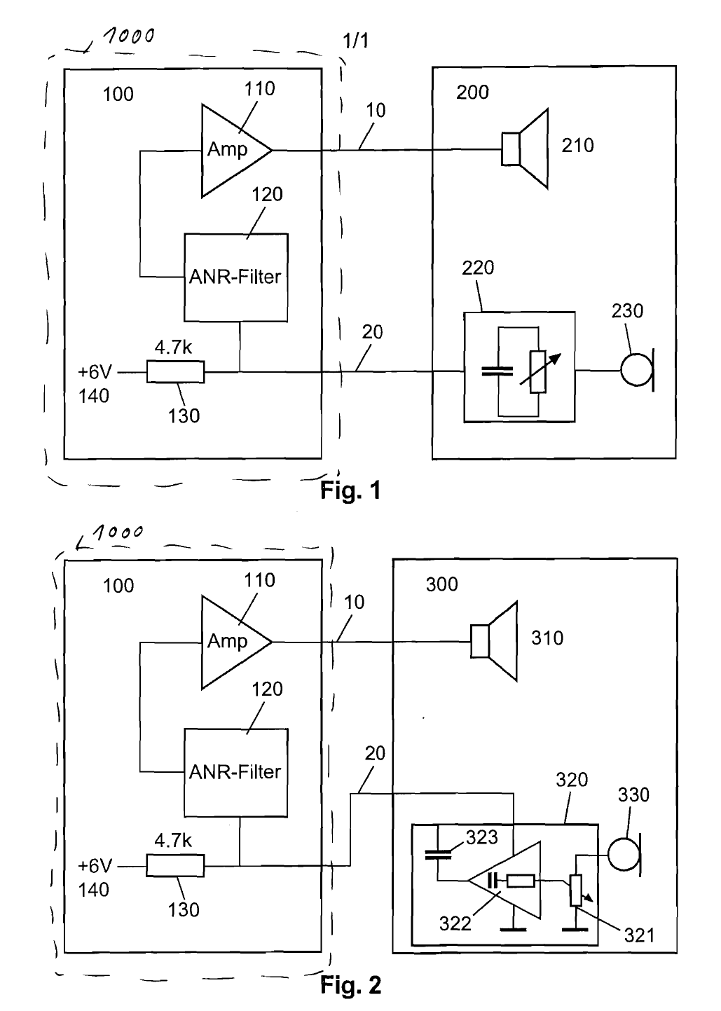

FIG. 1 shows a block diagram of a part of an entertainment system in accordance with the state of the art, and

FIG. 2 shows a block diagram of a part of an entertainment system in accordance with a first embodiment.

FIG. 1 shows a block diagram of a part of an inflight entertainment system in accordance with the state of the art. The inflight entertainment system has a multiplicity of electronic units 100 in seats 1000 and (head) phones 200. The electronic unit 100 and the (head) phone 200 are connected together by first and second lines 10, 20. Provided in the headphone 200 is an electro-acoustic reproduction transducer 210, a microphone 230 and an adjusting unit 220 with a filter. The microphone 230 is coupled to the filter and the adjusting unit 220, the output of the adjusting unit 220 being coupled to the electronic unit 100 by way of the second line 20. The adjusting unit 220 has a passive filter or a compensating resistor and an RL member. The electronic unit 100 has a voltage supply 140 of for example +6 volts. The electronic unit 100 further has an ANR filter 120 and an audio amplifier 110. The ANR filter 120 performs noise reduction based on the audio signals recorded by the microphone 230. The output of the amplifier 110 is coupled to the electro-acoustic transducer 210 by way of the first line 10.

FIG. 2 shows a block diagram of a part of an inflight entertainment system in accordance with a first embodiment. In this case the electronic unit 100 of the first embodiment substantially corresponds to the electronic unit in accordance with the state of the art. FIG. 2 also shows a headphone or earphone 300 having an electro-acoustic reproduction transducer 310 and a microphone 330, for example an electret microphone, which serves to record interference sound. In addition thereto the headphone or earphone 300 has an adjusting unit 320. The adjusting unit 320 can have for example an adjustable input resistor 321, an amplifier 322 and optionally a capacitor 323. The output of the adjusting unit 320 is coupled by way of the second line 20 to a first terminal of the electronic unit. The microphone receives a supply voltage by way of the first terminal.

The adjusting unit serves as a pre-filter for active noise reduction. In other words, it is possible to achieve distributed active noise reduction, in which case a part is implemented in the seat and a part in the earphone. It is possible to provide in that way that active noise reduction is adapted to the specific acoustics of the earphone. Thus the adjusting unit 320 serves as a pre-filter, while further filtering and in particular the required amplification effect takes place in the ANR filter 120.

The adjusting unit 320 also serves for correction of the transmission behaviour of the earphone and can provide for improved matching of the distributed active noise reduction to the acoustics of the earphone.

Optionally the adjusting unit 320 can also amplify the output signal of the microphone.

1. An entertainment system comprising:
at least one seat,
at least one electronic unit for active noise reduction, arranged in the seat, and
at least one earphone having an electro-acoustic reproduction transducer for the output of an audio signal, a microphone for recording interference signals and for the output of an output signal and an adjusting unit having an active filter for correcting a frequency response characteristic of the output signal of the microphone, for performing pre-filtration for active noise reduction and for outputting a corrected filtered signal,
wherein the electronic unit is adapted to perform active noise reduction based on the corrected and filtered signal of the adjusting unit.

2. An entertainment system as set forth in claim 1 wherein the electronic unit has a filter for active noise reduction and an amplifier for amplifying the active noise-reduced signal,
wherein the filtered and corrected signal of the adjusting unit is passed to the filter.

3. An earphone comprising:
at least one electro-acoustic transducer for the output of an audio signal,
a microphone for recording interference signals and for the output of an output signal, and
an adjusting unit having an active filter for correcting the frequency response characteristic of the output signal of the microphone, for performing pre-filtration for active noise reduction and for the output of the filtered and corrected signal.

4. A method of controlling an entertainment system comprising at least one seat, at least one electronic unit for active noise reduction in the seat and at least one earphone having a microphone for recording interference signals, comprising the steps:
performing active filtration of the output signal of the microphone to correct a frequency response characteristic of the output signal and to perform pre-filtration for active noise reduction, and
outputting a corrected filtered signal,
wherein active noise reduction is effected based on the corrected and filtered signal in the electronic unit.
